(19) United States
(12) Patent Application Publication
(10) Pub. No.: US 2014/0090732 A1
(43) Pub. Date: Apr. 3, 2014

(54) COMPACT PNEUMATIC NAILER WITH SUPPLEMENTAL AIR TANK

(71) Applicant: ILLINOIS TOOL WORKS INC., Glenview, IL (US)

(72) Inventors: Bryan R. Schieler, Palatine, IL (US); Nathan Mina, Lake in the Hills, IL (US); Christopher A. Horst, Antioch, IL (US); Ryan Francis, Palatine, IL (US)

(73) Assignee: Illinois Tool Works Inc., Glenview, IL (US)

(21) Appl. No.: 13/632,114

(22) Filed: Sep. 30, 2012

(51) Int. Cl. F15B 1/027; B25C 1/04

(52) U.S. Cl. 137/565.18; 227/130

(57) ABSTRACT

A pneumatic nailer system for use with a compressor having a main storage tank, includes a first air hose connected at one end to the compressor, a supplemental air storage tank connected to an opposite end of the first hose, and connected at a supply end to at least one second air hose, a pneumatic nailer connected to a tool end of the at least one second air hose, such that the supplemental air storage tank is located between the compressor and the at least one nailer. The supplemental air storage tank enables the pneumatic nailer(s) connected to the supplemental air storage tank to provide consistent drive energy for driving fasteners while reducing the internal air storage volume and overall size of the nailer.

### BACKGROUND

The present disclosure relates to fastener driving tools, and more particularly to pneumatically powered fastener drivers, also referred to as pneumatic nailers.

Conventional pneumatic nailers, such as those disclosed in U.S. Pat. No. 3,638,532 and US Patent Application Publication No. 2012/0223120-A1, both of which incorporated by reference herein, are connected to a source of compressed air, typically a compressor, via an extended length hose. Per industry standards, the compressors are set at a maximum output of 120 psi. In a conventional construction jobsite, where pneumatic nailers of this type are commonly used, the compressor hose can reach 200 feet (60.96 meters) in length. A major reason for the long hoses is that the users prefer to locate the compressor outside the residence or building where the construction work is being performed to reduce noise. A common drawback of such systems is that the nailer experiences a pressure drop over the length of the hose, such that a 110-130 psi output at the compressor can drop to approximately 90-100 psi at the nailer. In conventional framing nailers driving nails into pine boards, the required pressure for fully driving the fastener is approximately 100-110 psi. Thus, it is not uncommon for tools to incompletely drive the nails into the workpiece or substrate. The user then follows the nailer with a manual hammer for completing the fastener driving process.

One attempted solution to the pressure drop at the nailer is to provide the nailer with a housing that stores a residual supply of compressed air to buffer or supplement the air provided by the compressor. In such tools, sufficient storage space is provided to retain approximately 25% more compressed air volume than is required to drive a single nail. While the additional storage space in the tool addresses the pressure required to completely drive a single nail, it is customary for the pressure in a conventional nailer to decrease with subsequent fasteners driven in relatively close succession. For example, an initial fastener is driven at approximately 110 psi with the housing-stored pressure boost, the second at 100 psi, the third at 95 psi and the fourth at 90 psi. In such a scenario, the user will have to use his hammer to complete the driving of the second through fourth fasteners, with more manual energy required as the nailer output decreases.

A drawback of the enlarged tool housing, the conventional response to tool pressure drops described above, is that the tool is relatively heavy, at approximately 7.5-8.5 pounds (3.4-3.8 kg) for a framing-type tool. Pneumatic nailers are usually provided in two sizes, a relatively larger framing tool, and a relatively smaller trim tool. Another drawback of the conventional pneumatic nailer system described above is that the user encounters a physical drag on his efforts caused by the length and weight of the air supply hose, which at approximately 200 feet, is cumbersome to manipulate on the jobsite.

### SUMMARY

Various embodiments of the present disclosure provide a pneumatic nailer system featuring a pneumatic nailer having a significantly reduced housing size, such that the overall tool is approximately 25-30% lighter than a standard pneumatic framing tool. A main source of the reduction in size is the elimination of extra compressed air storage volume. More specifically, the housing of the present pneumatic tool is configured to store only enough compressed air to power the driving of a single fastener. This differs from conventional framing tools, where the housing includes or defines a buffer storage area to supplement the compressed air provided by the compressor, and for alleviating the typical pressure drop encountered when long hoses are used, and/or multiple tools are connected to a single compressor. Instead of in-tool compressed air storage, the pneumatic nailer system of the present disclosure provides a supplemental air tank located between the compressor and the tool for providing a more consistent supply of compressed air located closer to the nailer that is less susceptible to pressure drops.

Another benefit of the pneumatic nailer system of the present disclosure that internal storage, swept and return volumes are dimensioned in a way that has been found to significantly increase the power of the present tool relative to the size of the tool. With the present tool and the supplemental air tank, the tool generates approximately 80 Joules of energy for each fastener driving cycle, even after multiple fasteners are driven, with a tool weighing approximately 6 pounds. In other words, the present tool drives successive fasteners at approximately 100 psi on a more consistent basis than conventional pneumatic framing nailers connected by a hose directly to a compressor.

More specifically, a pneumatic nailer system is provided for use with a compressor having a main storage tank. In an embodiment, the system includes a first air hose connected at one end to the compressor, a supplemental air storage tank connected to an opposite end of the first hose, and connected at a supply end to at least one second air hose. A pneumatic nailer is connected to a tool end of a corresponding second air hose, such that the supplemental air storage tank is located between the compressor and the at least one nailer.

In an embodiment, a pneumatic nailer is provided, including a tool housing, a cylinder disposed in the tool housing and enclosing a reciprocating drive piston with a depending driver blade, and a tool nose connected to the housing and defining a channel for receiving the reciprocating driver blade. The housing defines or includes at least one internal storage space dimensioned for storing a supply of compressed air sufficient for driving only one fastener.

In an embodiment, a pneumatic nailer is provided, including a tool housing defining at least one internal chamber, a cylinder disposed in the at least one internal chamber, defining a piston end and an opposite driver blade end, and enclosing a reciprocating piston and driver blade, a tool nose connected to the housing and defining a passageway accommodating the driver blade upon exit from the driver blade end. The housing defines an internal storage volume in the at least one internal chamber separate from the cylinder. A swept volume is defined in the cylinder between the piston and the driver blade end, and a ratio of the storage volume to the swept volume being approximately 2.0 to 2.7.

In an embodiment, a pneumatic nailer is provided, including a tool housing defining at least one internal chamber, a cylinder disposed in the at least one internal chamber, defining a piston end and an opposite driver blade end, and enclosing a reciprocating piston and driver blade. A tool nose is connected to the housing and defines a passageway accommodating the driver blade upon exit from the driver blade end. The housing defines an internal storage volume in the at least one internal chamber separate from the cylinder. A return volume defined in the housing and being separate from the storage volume, and a ratio of the storage volume to the return volume being approximately 2.9-3.9.

In a further embodiment, a pneumatic nailer is provided, including a tool housing defining at least one internal chamber, a cylinder disposed in the at least one internal chamber, defining a piston end and an opposite driver blade end, and enclosing a reciprocating piston and driver blade powered by compressed air stored in the at least one chamber. A tool nose is connected to the housing and defines a passageway accommodating the driver blade upon exit from the driver blade end, and a magazine is configured for storing a supply of fasteners and delivering fasteners sequentially to the passageway. The pneumatic nailer weighs approximately 6 pounds and generates approximately 80 Joules per faster driving cycle at 100 psi.

### BRIEF DESCRIPTION OF THE DRAWINGS

FIG. 1 is a schematic of an example pneumatic nailer system including the supplemental air tank in accordance with an embodiment of the present disclosure;

FIG. 2 is a vertical cross-section of at least one of the compact pneumatic nailers of FIG. 1; and

FIG. 3 is an overhead plan view of an improved exhaust seal for the pneumatic nailer in accordance with an embodiment of the present disclosure.

### DETAILED DESCRIPTION

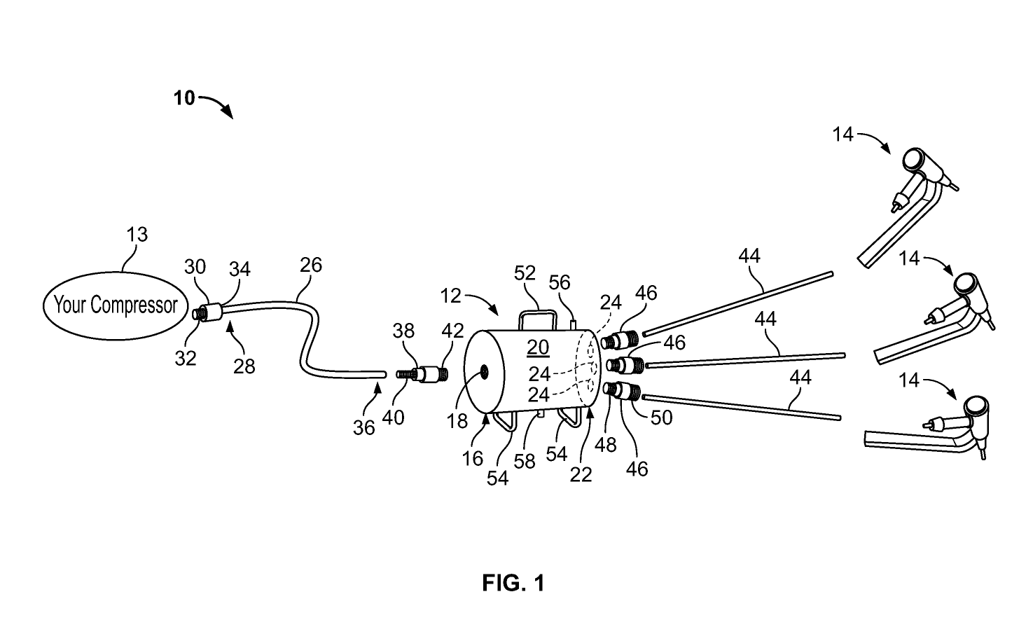

Referring to FIG. 1, the pneumatic nailer system 10 of the present disclosure includes a supplemental air storage tank 12 connected between a main storage tank of an air compressor 13 and one or more pneumatic fastening tools, such as pneumatic nailers 14 also referred to as tools. A main advantage of the supplemental air tank 12 is that it supplies additional pressurized air to the pneumatic fastening tools to compensate or adjust for air pressure losses that occurs in the long air hoses connecting conventional air compressors to pneumatic fastening tools. The result is more consistent fastener driving power being supplied to a relatively lighter nailer 14.

In the illustrated embodiment, the supplemental air tank 12 includes a first end 16 having a threaded inlet port 18 that is secured, as by welding to an outer surface 20 of the tank. An opposing second end 22 of the supplemental air tank 10 includes one or a plurality of threaded outlet ports 24 that are also secured, as by welding to the outer surface 20 of the tank. In an embodiment, the inlet port 18 and the outlet port or outlet ports 24 each have a ⅜ inch (0.953 cm) inside diameter. It should be appreciated, however, that the inlet port 18 and each outlet port 24 may be any suitable size and may be connected to the supplemental air tank 12 at any suitable location on the outer surface 20 of the tank.

Pressurized air from the main air tank of the air compressor 13 is communicated or directed to the supplemental air tank 12 via a compressor hose or first air hose 26. In certain embodiments, the compressor hose 26 preferably has a ⅜ inch (0.953 cm) diameter and a length of up to about 100 feet and preferably, 50 feet. However, it should be appreciated that, in various alternative embodiments, the compressor hose may be any suitable size or diameter. A first end 28 of the compressor hose 26 includes a hose coupler 30 having a nipple 32 and a receptacle 34. The nipple 32 is secured to a corresponding female-type outlet port on the main tank of the compressor 13. In an embodiment, the nipple 32 and the outlet port 24 are each threaded and the nipple is inserted into the female outlet port and turned until sufficiently tightened. The receptacle 34 is connected to the first end 28 of the compressor hose 26 by a ferrule and threaded nut (not shown). A sealant, such as Teflon® tape or other suitable sealant, may be added to the threads on the nipple to enhance the seal between the outlet port of the compressor 13 and the hose coupler 30. In another embodiment, the hose coupler 30 includes a quick-connect in place of the nipple 32 for enabling a user to quickly connect the compressor hose 26 to the compressor 13.

A second opposing end 36 of the first compressor hose 26 includes a check valve 38 that allows air to be communicated or supplied to the supplemental air tank 12 and prevents the compressed air from re-entering the compressor hose 26 from the supplemental air tank and moving toward the main air tank of the compressor 13. In the illustrated embodiment, the check valve 38 includes a ⅜ inch (0.953 cm) nipple 40, which is connected to the compressor hose 26 using a threaded connection or quick-connect as described above, and a receptacle 42 that is threadingly connected to the inlet port 18 of the supplemental air tank 10. A sealant, such as Teflon Tape® or other suitable sealant, may be added to the threads on the inlet port to enhance the seal between the inlet port and the check valve.

Each pneumatic nailer 14 is connected to one of the outlet ports 24 of the supplemental air tank 12 using a second air hose or tool air hose 44. The tool hoses 44 are each between ¼ inch and ⅜ inch (0.635 cm and 0.953 cm) in diameter and have a length between 0 to one hundred feet (30.48 m). In the illustrated embodiment, each tool hose 44 has a length of about 50 to 100 feet (15.24 to 30.48 cm) for supplying pressurized air from the supplemental air tank 12 to each pneumatic nailer 14. In the pneumatic nailer system 10 of the present disclosure, each end of each tool air hose 44 includes a ⅜ inch (0.953 cm) hose coupler 46 as described above having a threaded nipple 48 on one end and a threaded receptacle 50 on an opposing end. It should be appreciated that the hose coupler 46 may also be a ¼ inch (0.600 cm) coupler. Alternatively, as is well known in the art, one end of the hose coupler 46 attached to each end of the tool air hose 44 includes a quick connect and the opposing end includes a receptacle for respectively securing the tool hose to the supplemental air tank 12 and one of the pneumatic nailers 14.

In the above example embodiment, the supplemental air tank 12 has a nine gallon air capacity and is made of steel. It should be appreciated, however, that the supplemental air tank may be any suitable size and be made of any suitable material or combination of materials. As shown in FIG. 1, the supplemental air tank 12 includes a handle 52 located on top of the tank for transporting the tank from job site to job site. A pair of angled supports or feet 54 is attached to a bottom of the supplemental air tank 12 to enable the tank to securely stand on an underlying surface such as on the ground or scaffolding. The supplemental air tank 12 further includes a safety relief valve 56 for releasing excess pressure that builds up within the tank and a drain 58 for releasing moisture and water that accumulate inside of the tank during use.

As stated above, conventional air compressors are connected directly to a pneumatic nailer by a long hose that is approximately 200 feet. The long hose is desired by users so that noisy air compressors can be placed a sufficient distance away from a job site such as a house or building. The drop in air pressure over the long air hose, however, results in inconsistent fastening results. In addition, the long hose is cumbersome to manipulate by users. The pneumatic nailer system 10 of the present disclosure overcomes this problem by providing the supplemental air tank 12 between the compressor 13 and each pneumatic nailer 14, in which the pressurized air travels a shorter distance through the compressor hose 26 and each tool hose 44, i.e., 50 to 100 feet (15.24 to 30.48 cm), and thereby provides a sufficient amount of pressurized air to each pneumatic nailer to fully drive one or more fasteners into a workpiece. In an embodiment, the supplemental air tank 12 is located midway between the compressor 13 and the pneumatic nailer(s) 14. Specifically, in such an embodiment, the pressurized air is approximately 100-110 psi at the outlet port of the main compressor and approximately 100 psi at the inlet port to each pneumatic nailer 14, thereby reducing the pressure drops experienced in conventional pneumatic nailer systems and providing more consistent fastening results.

In operation, the main compressor supplies pressurized air to the compressor hose 26 via the hose coupler 30. The pressurized air flows through the compressor hose 26 and into the supplemental air tank 12. Because the air pressure decreases as it travels through the compressor hose 26, the supplemental air tank 12 generates pressurized air that supplements the air received from the main compressor 13. This helps to maintain a consistent air pressure in the hose lines to provide consistent fastening results. The supplemented pressurized air is supplied to each of the tool air hoses 44 connected to the supplemental air tank 12 and then travels to each of the pneumatic nailers 14 for driving fasteners into a workpiece.

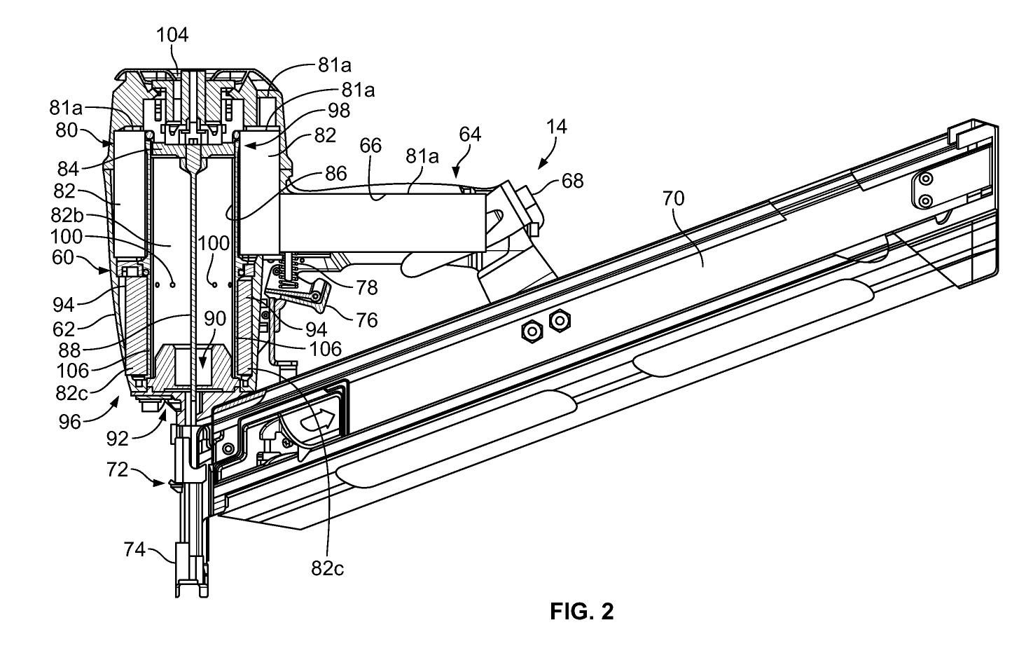

Referring now to FIG. 2, the pneumatic nailer 14 (also referred to herein as a “pneumatic tool” or “tool” or “nailer”) includes a housing 60 having a generally vertically extending portion 62 and a rearwardly extending handle portion 64 defining and enclosing a fluid reservoir 66. A pneumatic air connection nipple 68 projects rearwardly from the handle portion 64. As described above, the end of the tool air hose 44 is connected to the connection nipple 68 and pressurizes the fluid reservoir 66, and the opposing end of the tool air hose 44 is connected to the supplemental air storage tank 12 (FIG. 1). As is known in the art, a magazine 70 feeds fasteners to a tool nose 72 having a workpiece contact element (“WCE”) 74, the latter vertically reciprocally slidable relative to the nose so that it retracts upon the use pressing the pneumatic nailer 14 against a workpiece prior to driving a fastener. A trigger 76 controls a trigger valve 78 located within the housing 60. As is the case with conventional pneumatic nailers, in the tool 14 the WCE 74 is mechanically linked to the trigger valve 78, so that the trigger valve is actuable by movement of both the trigger 76 and the WCE 74 concurrently.

The housing 60 of the pneumatic nailer 14 includes at least one internal chamber 80 having a total storage volume for storing and conveying the pressurized air within the tool 14 that is approximately 25-30% less than the internal air storage space of conventional pneumatic nailers. The smaller internal chamber 80 results in the overall size of the pneumatic nailer 14 being smaller, lighter in weight and more compact than conventional pneumatic nailers. In the illustrated embodiment, the overall weight of the pneumatic nailer 14 is approximately 6 pounds and the total storage volume is less than 1000 mL while still sufficient to drive a single fastener into a workpiece. For example, a preferred volume may be 941 mL, which may vary to suit the situation. In comparison, conventional pneumatic nailers weigh approximately 7.5-8.5 pounds and have total internal air storage volume greater than 1000 mL.

The total internal volume of the present pneumatic nailer 14 of the present disclosure is composed of three different air volumes defined within the internal chamber 80: an internal storage volume 81a, a swept volume 82b and a return volume 82c. The internal storage volume 81a includes the combination of the air volumes defined by the fluid reservoir 66 in the handle and an upper annular area 82 shown in FIG. 2. The pressurized air from the tool air hose 44 flows through the fluid reservoir 66, the upper annular area 82 and then against the piston 84 for driving the piston through the cylinder 86 upon actuation of the trigger switch of the pneumatic nailer 14, as is well known in the pneumatic nailer art.

The swept volume 81b is the ambient air volume defined by the space inside the cylinder 86 between the piston 84 and the free end of the driver blade 88. This volume of air is “swept” or forced out of the cylinder and out through an exhaust opening or exhaust gap 90 at the bottom end 92 of the cylinder 86 when the piston 84 moves through the cylinder upon actuation of the pneumatic nailer 14.

The return volume 81c is defined by an annular return air chamber 94 at a lower end 96 of the housing 60 and in fluid communication with the cylinder 86 as shown in FIG. 2. After actuation, the piston 84 moves back toward the upper end 98 of the cylinder 86. The pressurized air in the return air chamber 94 enters the cylinder 86 through return openings or slots 106 at the bottom of the cylinder under the piston 84 to help push the piston back to the upper end 98 of the cylinder prior to the next actuation of the pneumatic nailer 14.

One problem with conventional pneumatic nailers is that, due in part to the pressure drop caused by the extended length hose, the available drive energy needed to drive fasteners into a workpiece decreases with each successive actuation of the tool. For example, approximately 80 Joules of drive energy at 100 psi is needed to fully drive a fastener into a workpiece. However, the pneumatic power available to conventional nailers decreases after each successive actuation or shot so that some fasteners are not fully driven into a workpiece due to decreased drive energy. Since drive energy is generally linearly related to storage volume, the pneumatic nailer system of the present disclosure including the supplemental air tank 12, and the relatively small storage volume of the pneumatic nailer 14 is configured to provide consistent drive energy for each actuation of the nailer.

The pneumatic nailer 14 generates 80 Joules of drive energy at 100 psi of air pressure in each actuation of the nailer to drive a single fastener, such as a conventional framing nail, into a workpiece. Further, the pneumatic nailer 14 generates 70 Joules of drive energy at an air pressure of 90 psi and 101 Joules at 120 psi. In the illustrated embodiment, the total storage volume is 941 mL to generate the 80 Joules of drive energy where the total storage volume includes an internal storage volume of 530 mL, a swept volume of 241 mL and a return volume is 170 mL.

Further, the total storage volume of the pneumatic nailer 14 is configured to generate 80 Joules of drive energy at 100 psi in each actuation of the tool. Specifically, a first ratio of the internal storage volume 81a to the swept volume 81b is in the range of 2.0 to 2.7, and preferably 2.26. Furthermore, a preferred second ratio of the internal storage volume 81a to the return volume 81c is approximately 3.1 but is contemplated to be in the range of 2.9 to 3.9. The resulting ratio of the swept volume 81b to the return volume 81c is dependent on the first and second ratios. By maintaining these ratios, the pneumatic nailer 14 consistently generates 80 Joules of drive energy per each actuation while decreasing the overall size and weight of the tool. This is a significant benefit to a user that must carry and use the pneumatic nailer throughout a day at the same or different job sites.

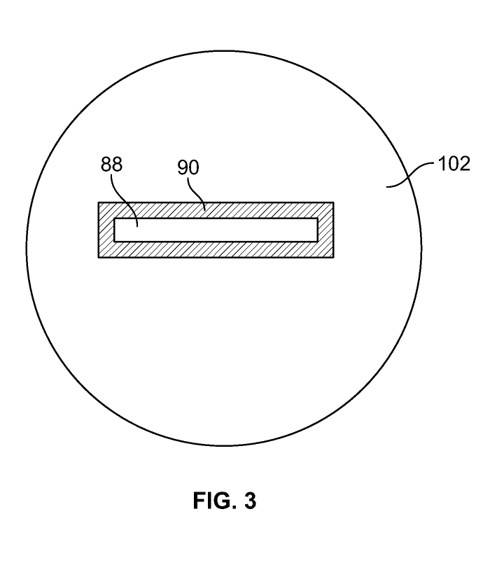

Referring now to FIG. 3, the pneumatic nailer 14 of the present disclosure includes the exhaust opening or gap 90 between a metal seal plate 102 at the bottom end 92 of the cylinder 86 and the driver blade 88. The gap 90 is open to atmosphere at all times. Therefore, it is important not to make it too large because it will impede the building up of adequate pressure in the return chamber 94 to effectively return the piston 84 and the driver blade 88 to the top of the cylinder 86. In operation, the piston 84 is driven downward through the cylinder 86, which forces the air beneath the piston through check valve openings 100 and into the return chamber 94. After a fastener is driven into a workpiece and the return of the piston 84 has started, the remaining storage air above the piston is vented to atmosphere through exhaust openings 104 in the top of the housing 60. The return volume air in the return chamber 94 expands and enters the bottom end 92 of the cylinder 86 through return openings 106 to propel the piston 84 back to the upper end 98 of the cylinder 86. It is important to vent all of the return air pressure to atmosphere before the next actuation cycle starts, or the pressure below the piston 84 will be greater than atmospheric pressure, and will counteract the downward pressure forces on the piston by the internal storage air, effectively reducing the energy delivered to the driven fastener. Thus, the gap 90 needs to be sufficiently large to allow the return air below the piston 84 to vent to atmosphere out the tool nose 72 before the next actuation cycle but not too large to impede the buildup of pressure in the return chamber 94 as described above. In the illustrated embodiment, the exhaust opening or exhaust gap 90 is preferably 0.0206 square inches (0.133 square cm) to meet the above operational criteria. It should be appreciated, however, that the exhaust opening 90 may be any suitable size that maintains the drive energy at 80 Joules.

While particular embodiments of the pneumatic nailer 14 with supplemental air tank 12 has been shown and described, it will be appreciated by those skilled in the art that changes and modifications may be made thereto without departing from the invention in its broader aspects and as set forth in the following claims.

What is claimed is:

1. A pneumatic nailer system for use with a compressor having a main storage tank, said pneumatic nailer system comprising:
a first air hose connected at one end to the compressor;
a supplemental air storage tank connected to an opposite end of said first air hose, and connected at a supply end to at least one second air hose; and
at least one pneumatic nailer connected to a tool end of a corresponding said at least one second air hose, wherein said supplemental air storage tank is located between the compressor and said at least one pneumatic nailer.

2. The system of claim 1, wherein said first air hose and said at least one second air hose are each at least 50 feet in length and less than or equal to 100 feet in length.

3. The system of claim 1, wherein said supplemental air storage tank is located midway between the compressor and said at least one pneumatic nailer.

4. The system of claim 1, further including a check valve in fluid communication said first air hose and said supplemental air tank.

5. The system of claim 1, wherein said at least one pneumatic nailer weighs approximately 6 pounds and generates approximately 80 Joules per faster driving cycle at 100 psi.

6. The system of claim 5, wherein said at least one pneumatic nailer generates 80 Joules per fastener after multiple fasteners are driven.

7. The system of claim 1, wherein said at least one pneumatic nailer is provided with an interior storage volume sufficient for driving only a single fastener.

8. The system of claim 1, wherein said at least one second air hose is directly connected to said supplemental air tank.

9. A pneumatic nailer, comprising:
a housing;
a cylinder disposed in said housing and enclosing a reciprocating drive piston with a depending driver blade; and
a tool nose connected to said housing and defining a channel for receiving the reciprocating driver blade;
said housing defining at least one internal storage space dimensioned for storing a supply of compressed air in communication with said cylinder and sufficient for driving only one fastener.

10. The pneumatic nailer of claim 9, wherein said at least one internal storage space is less than 1,000 mL.

11. A pneumatic nailer comprising:
a housing defining at least one internal chamber;
a cylinder disposed in said at least one internal chamber, defining a piston end and an opposite driver blade end, and enclosing a reciprocating piston and driver blade;
a tool nose connected to said housing and defining a passageway accommodating said driver blade upon exit from said driver blade end; and
a swept volume defined in said cylinder between said piston and said driver blade end;
wherein said housing defines an internal storage volume in said at least one internal chamber separate from said cylinder; and
wherein a ratio of said storage volume to said swept volume is approximately 2.0 to 2.7.

12. A pneumatic nailer comprising:
a housing defining at least one internal chamber;
a cylinder disposed in said at least one internal chamber, defining a piston end and an opposite driver blade end, and enclosing a reciprocating piston and driver blade;
a tool nose connected to said housing and defining a passageway accommodating said driver blade upon exit from said driver blade end; and
a return volume defined in said housing and being separate from said storage volume;
wherein said housing defines an internal storage volume in said at least one internal chamber separate from said cylinder; and
wherein a ratio of said storage volume to said return volume is approximately 2.9 to 3.9.

13. A pneumatic nailer comprising:
a housing defining at least one internal chamber;
a cylinder disposed in said at least one internal chamber, defining a piston end and an opposite driver blade end, and enclosing a reciprocating piston and driver blade powered by compressed air stored in said at least one chamber;
a tool nose connected to said housing and defining a passageway accommodating said driver blade upon exit from said driver blade end; and
a magazine configured for storing a supply of fasteners and delivering said fasteners sequentially to the passageway;
wherein said pneumatic nailer weighs approximately 6 pounds and generates approximately 80 Joules per faster driving cycle at 100 psi.

14. The nailer of claim 13 further including a swept volume defined in said cylinder between said piston and said driver blade end;
wherein said housing defines an internal storage volume in said at least one internal chamber separate from said cylinder; and
wherein a ratio of said storage volume to said swept volume being approximately 2.0 to 2.7.

15. The nailer of claim 13, wherein said housing defines an internal storage volume in said at least one internal chamber separate from said cylinder;
a return volume defined in said housing and being separate from said storage volume; and
a ratio of said storage volume to said return volume is approximately 3.1.

16. The nailer of claim 13, further including a seal between said housing and said passageway and having an opening configured for accommodating reciprocation of said driver blade and having a dimension for facilitating release of return volume pressurized air from below the piston during the return cycle of the nailer.
